(19) United States
(12) Patent Application Publication
(10) Pub. No.: US 2010/0217920 A1
(43) Pub. Date: Aug. 26, 2010

(54) Memory system and address allocating method of flash translation layer thereof

(75) Inventor: Jong-uk Song, Yongin-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/654,388

(22) Filed: Dec. 18, 2009

(30) Foreign Application Priority Data
Feb. 26, 2009 (KR) 10-2009-0016402

(51) Int. Cl. G06F 12/02; G06F 12/00

(52) U.S. Cl. 711/103; 711/170; 711/154; 711/E12.001; 711/E12.002; 711/E12.008

(57) ABSTRACT

The memory system includes a flash memory and a memory controller. The flash memory has at least two addresses with different program times. The memory controller is configured to control the flash memory. The memory controller is configured to assign an address corresponding to a shorter program time from among the at least two addresses for a write operation executed at interruption of a power supply to the flash memory. The assigned address is used to store data of the memory controller in the flash memory.

### CROSS-REFERENCE TO RELATED APPLICATIONS

A claim of priority under 35 U.S.C §119 is made to Korean Patent Application No. 10-2009-0016402 filed Feb. 26, 2009, the entirety of which is incorporated herein by reference.

### BACKGROUND

1. Technical Field

Example embodiments of the present invention relate to a memory system and an address allocating method of a flash translation layer of the memory system.

2. Description of the Related Art

A general memory system may include a memory device for storing data and a controller for controlling the memory device. The memory device may be classified into a volatile memory device such as DRAM, SRAM, or the like and a non-volatile memory device such as EEPROM, FRAM, PRAM, MRAM, a flash memory, or the like.

A volatile memory device loses data stored therein at power-off, while a non-volatile memory device retains data stored therein even at power-off. Flash memory devices have been widely used as data storage media due to characteristics such as rapid program speed, low power consumption, large volume, and the like.

High-density memory devices may be more likely to be defective owing to many limitations of a fabrication process. Endeavors have been made to better increase yield and reduce errors for high integration of memory devices. It is assumed that a memory device installed within a memory system is used. With this assumption, it may be difficult for a user to judge the defectiveness of a memory device.

A large-volume storage device such as a flash memory card or a Solid State Drive/Disk (SSD) is configured to include a plurality of flash memory chips. If the number of bad blocks in one or more flash memory chips suddenly increases owing to program/erase fails, reserved blocks of the flash memory chip all may become used. In this case, it may be impossible to use a storage device with such flash memory chips.

Recently, there has been research in SSDs using semiconductor memory devices. The SSD may be superior to a rotary disk in terms of the reliability and speed. As a result, a computing system using the SSD instead of the hard disk as a storage device has been developed.

### SUMMARY

According to an embodiment of the inventive concept, an address allocating method of a flash translation layer includes judging whether interruption of a power supply is predicted and assigning one of a plurality of addresses having different program times according to a result of the judgment.

According to another embodiment of the inventive concept, a memory system includes a flash memory and a memory controller. The flash memory has at least two addresses with different program times. The memory controller is configured to control the flash memory. The memory controller is configured to assign an address corresponding to a shorter program time from among the at least two addresses for a write operation executed at interruption of a power supply to the flash memory. The assigned address is used to store data of the memory controller in the flash memory.

According to yet another embodiment of the inventive concept, a memory system includes a storage medium and a memory controller. The storage medium includes a plurality of storage spaces with different program times. The memory controller includes a buffer memory for temporarily retaining data to be stored in the storage medium. The memory controller is configured to predict interruption of a power supply to the storage medium. The memory controller is configured to control the storage medium such that the data in the buffer memory is stored in a storage space having a shorter program time than that of at least another storage space from the among the plurality of storage spaces if the memory controller predicts interruption of the power supply.

### BRIEF DESCRIPTION OF THE DRAWINGS

The above and other features of the inventive concepts will become apparent from the following description with reference to the following figures, wherein like reference numerals refer to like parts throughout the various figures unless otherwise specified, and wherein:

FIG. 1 is a block diagram showing a computing system according to an embodiment of the inventive concept;

FIG. 2 is a diagram showing the software layer architecture of a memory system in FIG. 1;

FIG. 3 is a flow chart for describing a write method of a memory system according to an embodiment of the inventive concept;

FIG. 4 is a block diagram showing a computing system according to another embodiment of the inventive concept;

FIG. 5 is a block diagram showing a memory system according to still another embodiment of the inventive concept;

FIG. 6 is a block diagram a memory system according to yet another embodiment of the inventive concept; and

FIG. 7 is a block diagram showing a Solid State Drive (SSD) to which memory systems according to embodiments of the inventive concepts are applied.

### DETAILED DESCRIPTION

Various example embodiments will be described more fully with reference to the accompanying drawings, in which some example embodiments are shown. The present inventive concepts may, however, be embodied in many different forms and should not be construed as limited to the embodiments set forth herein. Rather, these embodiments are provided so that this disclosure will be thorough and complete, and will fully convey the scope of the present inventive concepts to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present inventive concepts. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures. The figures are intended to depict example embodiments and should not be interpreted to limit the intended scope of the claims. The accompanying figures are not to be considered as drawn to scale unless explicitly noted.

The terminology used herein is for the purpose of describing particular embodiments and is not intended to be limiting of the inventive concepts. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which these inventive concepts belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A flash translation layer of a memory system according to an embodiment of the inventive concepts may be realized such that there is assigned an address corresponding to a relatively short program time for a write operation executed when interruption of a power supply is predicted. Herein, it is assumed that a program time varies according to an address used for the write operation. According to an embodiment of the inventive concept, a write operation may be executed more rapidly at interruption of a power supply. As compared with a conventional memory system, it is possible to reduce a capacity and a power maintenance time of an auxiliary power supply device of the memory system according to an embodiment of the inventive concept. Thus, manufacturing cost of a memory system may be reduced.

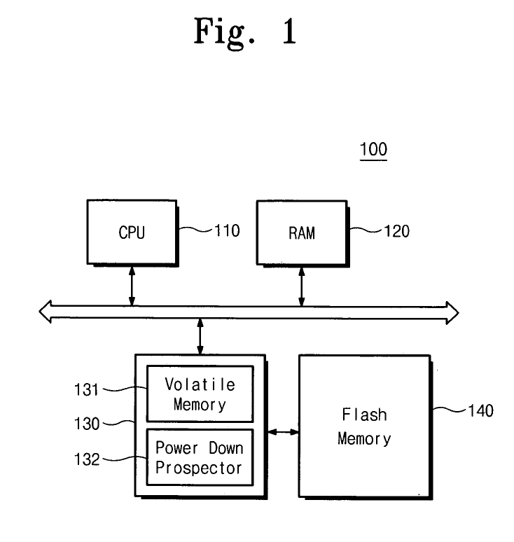

FIG. 1 is a block diagram showing a computing system according to an embodiment of the inventive concept. Referring to FIG. 1, a computing system 100 according to an embodiment of the inventive concepts may include a CPU 110, a RAM 120, a memory controller 130, and a flash memory 140. The CPU 110 may be configured to control an overall operation of the computing system 100. The RAM 120 may be used as a main memory of the computing system 120. The memory controller 130 may include a volatile memory 131 and a power down prospector 132, which is configured to predict interruption of a power supply (e.g., power-down).

The memory controller 130 and the flash memory 140 may constitute a memory system (or, a flash memory system). It will be understood that an embodiment of the inventive concepts is not limited to a system including a flash memory. For example, an embodiment of the inventive concepts may be applied to systems including non-volatile memories such as NAND flash memory, NOR flash memory, MRAM, PRAM, FRAM, and the like.

The volatile memory 131 may be used to temporarily store data needed for an operation of the memory controller 130. The volatile memory 131 may be formed from at least one of DRAM, SRAM, and the like. For example, the memory controller 130 of an embodiment of the inventive concepts may be realized to store data stationed at the volatile memory 131 in the flash memory 140 when the power-down is predicted. For example, the memory controller 130 of an embodiment of the inventive concepts may be realized to store data of the volatile memory 131 in the flash memory 140 before a power supply is interrupted.

The memory controller 130 may control the flash memory 140 according to a read/write request of a host (not shown). Although not shown, the controller 130 may include elements such as a processing unit, a host interface, a memory interface, and the like. The processing unit may control an overall operation of the controller 130. The host interface may include a protocol to exchange data between the host (e.g., CPU 110) and the controller 200. For example, the controller 130 may be configured to communicate with the host via one of interface protocols such as USB, MMC, PCI-E, ATA (Advanced Technology Attachment), Serial-ATA, Parallel-ATA, SCSI, ESDI, and IDE (Integrated Drive Electronics). The memory interface may interface with the flash memory 140. The controller 130 may further include an ECC engine for correcting errors of data read out from the flash memory 140.

In an embodiment of the inventive concepts, the memory controller 130 and the flash memory 140, e.g., the memory system, may be applied to applications such as a PDA, portable computer, web tablet, wireless phone, mobile phone, digital music player, digital audio recorder, digital audio player, digital picture recorder, digital picture player, digital video recorder, digital video player, devices for sending and receiving information at a wireless environment, one of various electronic devices constituting a home network, one of various electronic devices constituting a computer network, RFID device, one (for example, SSD, memory card) of the elements constituting a computing system, etc.

The power-down prospector 132 of the memory controller 130 may be configured to predict a power-down by sensing a power line or a data/command line. Alternatively, the power-down prospector 132 may be configured to predict the power-down in response to a command provided according to a request of the host. Herein, the command provided according to a request of the host may include a power-off command or a sleep command. In the event that the memory system 130 and 140 is a Solid State Drive (SSD), the power-down prospector 132 may be connected with a separate command line for receiving a sudden power-off command.

When the power-down is predicted by the power-down prospector 132, the memory controller 130 may assign an address corresponding to the shortest time to program data (for example, valid data) in the volatile memory 131 and control the flash memory 140 such that the data is stored in a page (or, a stage space) of the flash memory 140 corresponding to the assigned address. Herein, it is assumed that a program time varies according to an address. For example, as compared with an address of a multi-level cell (MLC), an address of a single level cell (SLC) may correspond to a relatively shorter program time. Further, for an MLC flash memory, a program time corresponding to an address of a least significant bit (LSB) of data may be shorter than that of a most significant bit (MSB) of data.

As understood from the above description, at such a write operation that interruption of a power supply is predicted, the memory controller 130 may be configured to select one address, corresponding to the shortest program time, from the writable addresses and store data in a page of the flash memory 140 corresponding to the selected address.

The flash memory 140 may include a meta area (not shown) for storing management information needed to manage the flash memory 140 and a data area for storing user data. The flash memory 140 of an embodiment of the inventive concepts may include at least two different program times corresponding to different addresses.

At a write operation executed when interruption of a power supply is predicted, the memory controller 130 may be configured to select an address having the shortest program time and to store data in a storage space corresponding to the selected address. This enables a program operation to be completed within a time shorter than a limited power supply time. As a result, the memory system 100 of an embodiment of the inventive concepts may better the stability for data when a power-down is predicted.

Further, the memory controller 130 of an embodiment of the inventive concepts may include an auxiliary power supply device, which is used to supply a power during a given time at interruption of a power supply. As compared with an auxiliary power supply device of a conventional memory system, it is possible to reduce a power maintenance time of the auxiliary power supply device of the memory system according to an embodiment of the inventive concepts. This is because the memory system (130 and 140) is realized to select an address with the shortest program time and to store data in a storage space corresponding to the selected address, at a write operation executed when interruption of a power supply is predicted. For example, the memory controller 130 of an embodiment of the inventive concepts may reduce a program time needed to perform a write operation at interruption of a power supply as compared with a conventional memory system. Since a program time needed to perform a write operation at interruption of a power supply is reduced, it is possible to reduce the capacity of an auxiliary power supply device of the memory system according to an embodiment of the inventive concepts. Thus, the memory system (130 and 140) may increase integration and reduce costs.

In an embodiment of the inventive concepts, the memory controller 130 may be configured to select one of at least two address allocation manners or protocols according to whether a power supply is interrupted. In accordance with an address allocation manner selected when a power supply is interrupted, the memory controller 130 assigns an address to data stored in a volatile memory such that valid data in the volatile memory is restored in one storage space of a flash memory having a program time that is shorter than that of another storage space, regardless of a mapping table. On the other hand, in accordance with an address allocation manner selected when no power supply is interrupted, the memory controller 130 assigns an address to data stored in the volatile memory based on a mapping table.

A conventional memory system is designed such that a power line is longer in length than a data line to supply a power supply longer. On the other hand, the memory system 100 of an embodiment of the inventive concepts makes it possible to reduce a difference in length between a power line and a data line as compared with a conventional memory system. This is because the memory system 130 and 140 according to an embodiment of the inventive concepts performs a write operation more rapidly than the conventional memory system when a power-down is predicted.

A flash memory is able to provide a rapid read speed for a relatively low cost as compared with other memory devices. However, the flash memory is characterized by having an erase operation executed prior to a write data operation and having a write unit that is different in size from an erase unit. This characteristic may limit a usage of the flash memory as a main memory. Further, in the event that the flash memory is used as an auxiliary memory device, the erase characteristic may act as a factor which hinders a conventional hard disk file system from being applied to a memory system including a flash memory without modification.

Due to such a flash memory characteristic, a memory system (or, a flash memory system) including a flash memory may include a software module for effectively managing the flash memory. The software module for managing the flash memory is called a Flash Translation Layer (FTL). The FTL may perform a role of mapping a logical address generated by a file system to a physical address of a flash memory to be erased at a write operation of the flash memory. The FTL may utilize an address mapping table to perform an address mapping operation rapidly.

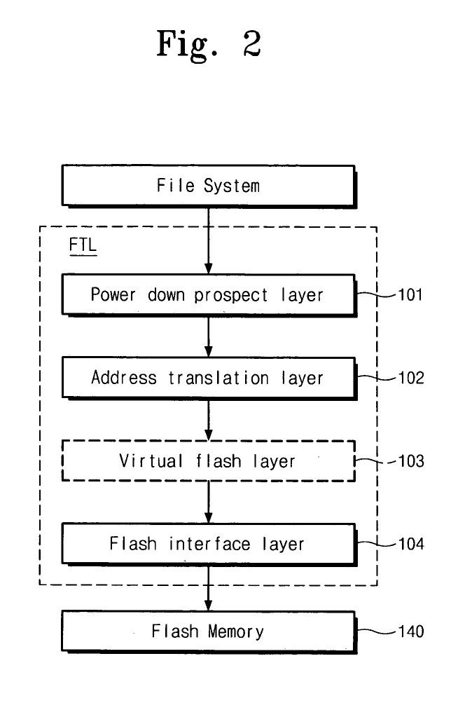

FIG. 2 is a diagram showing the software layer architecture of a memory system in FIG. 1. Referring to FIG. 2, FTL may translate an address for a read/write operation of a flash memory using logical addresses transferred from a file system. Addresses sent from the file system may be requested from a host (not shown). For example, the FTL may translate a logical address LA sent from the host into a physical address PA. Generally, the FTL of an embodiment of the inventive concepts may include a policy of assigning an address based on a program time when a power-down is predicted.

As illustrated in FIG. 2, the FTL may be divided into a power-down prospect layer 101, an address translation layer 102, a virtual flash layer 103, and a flash interface layer 164.

The power-down prospect layer 101 may predict a power-down of a memory system 130 and 140. Herein, prediction of the power-down may be accomplished by confirming whether a power-off command or a sleep command is sent from a host or whether a voltage level of a power line or a data line is dropped.

The address translation layer 102 may translate a logical address LA sent from a file system into a logical page address. The address translation layer may perform an address translation operation for a logical address space according to a result of the power-down prospect layer 101.

When a power-down is predicted by the power-down prospect layer 101, the address translation layer 102 may assign a logical page address LPA having the shortest program time of a flash memory to a logical address sent from the file system. On the other hand, when no power-down is predicted, the address translation layer 102 may translate a logical address LA sent from the host based on mapping information by which a logical page address LPA of the flash memory is mapped. The mapping information may be stored in a meta area of the flash memory.

The virtual flash layer 103 may translate a logical page address LPA translated by the address translation layer 102 into a virtual page address VPA. Herein, the virtual page address VPA may correspond to a physical address of a virtual flash memory. The virtual flash memory does not include bad blocks by completing a bad block processing procedure of a flash memory. For example, a virtual page address may correspond to a physical block of the flash memory except bad blocks.

The virtual flash layer 103 may perform a control operation on a controller of a flash memory instead of the flash memory needing an erase operation, at interface operations of the address translation layer, executed in a memory controller 130, and other operations.

The flash interface layer 104 may translate a virtual page address of the virtual flash layer into a physical page address of a flash memory 140. The flash interface layer 104 may execute a low-level operation for interfacing with the flash memory 140. For example, the flash interface layer 104 may include a low-level driver for controlling the flash memory 140, an ECC module for correcting errors data read out from the flash memory 140, a bad block management module, and the like.

The FTL according to an embodiment of the inventive concepts may include a power-down prospect layer 101 for predicting a power-down and an address translation layer 102 for changing an address assignment manner of a flash memory 140 according to a result predicted by the power-down prospect layer 101. It is possible to perform a program operation rapidly at power-down.

The flash translation layer illustrated in FIG. 2 is shown to include the virtual flash layer 103. However, in an embodiment of the inventive concepts, the flash translation layer may also be realized without including the virtual flash layer.

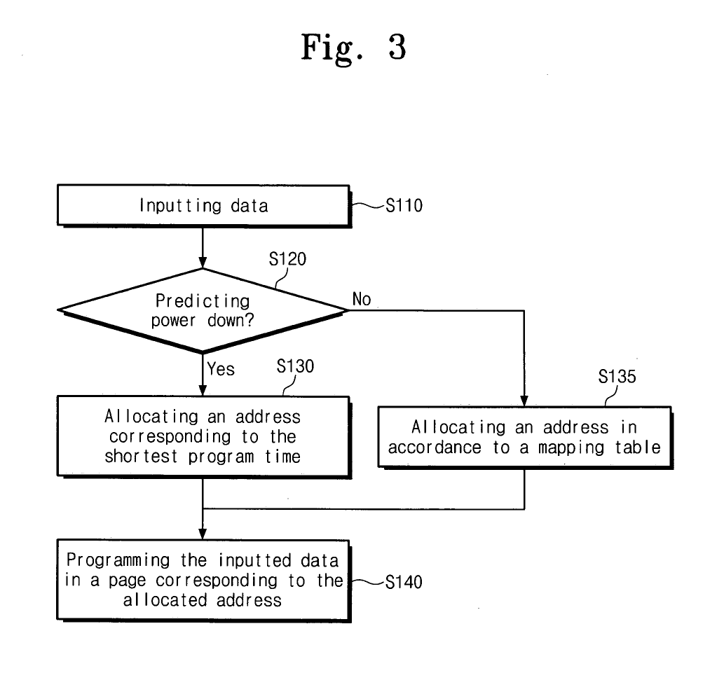

FIG. 3 is a flow chart for describing a write method of a memory system according to an embodiment of the inventive concepts. Below, a write operation of the memory system 100 will be fully described with reference to FIGS. 1 to 3.

In step S110, data to be written may be provided to a memory controller 130 at a write request of a host. At this time, the data to be written may be sent together with a write command and an address to the memory controller 130.

In step S120, the power-down prospector 132 of the memory controller 130 may judge whether a power-down is predicted. For example, the power-down prospector 132 may sense whether a voltage level of a power line or a data line in a memory system 130 and 140 is dropped or whether a power-down command or a sleep command is sent from a host.

If the power-down is predicted, the memory controller 130 may assign an address corresponding to a storage space having the shortest program time as an address at which data is to be stored. For example, in step S130, the memory controller 130 may translate an address received from the host into a page address having the shortest program time.

If no power-down is predicted, the memory controller 130 proceeds to step S135, in which the memory controller 130 assigns an address, at which data is to be stored, using a mapping table. Afterwards, in step S140, the memory controller 130 may control a flash memory 140 such that data is programmed in a page corresponding to the assigned address.

For the write method of the memory system 100 according to an embodiment of the inventive concepts, an address allocation manner may be realized differently based on a result predicted by a power-down prospector 132. For example, there is assigned an address having the shortest program time at a write operation executed when the power-down is predicted.

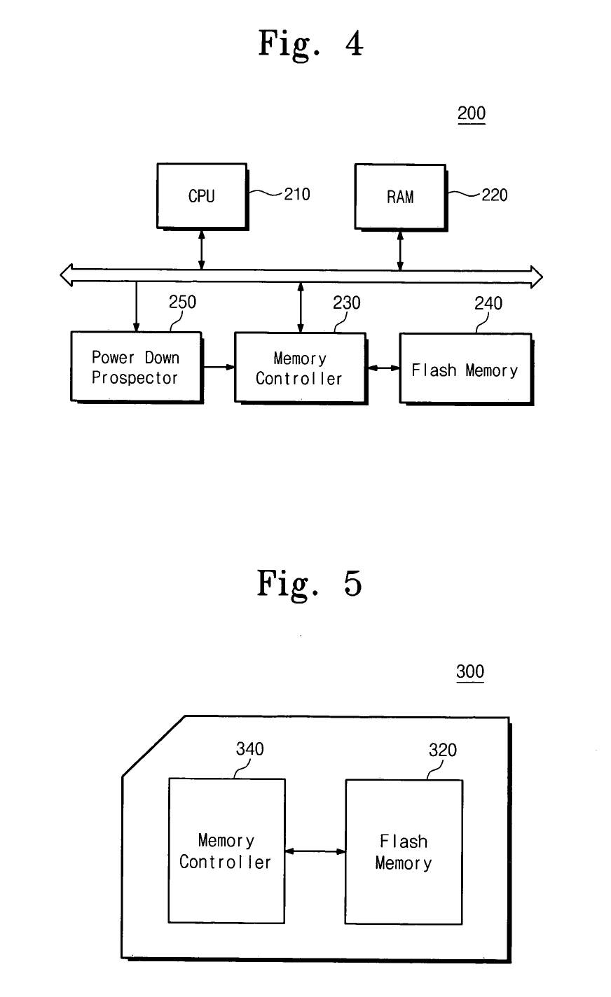

FIG. 4 is a block diagram showing a computing system according to another embodiment of the inventive concepts. Referring to FIG. 4, a computing system 200 according to an embodiment of the inventive concepts may include a CPU 210, a RAM 220, a memory controller 230, a flash memory 240, and a power down prospector 250.

Referring to FIG. 4, the computing system 200 may be realized such that the power-down prospector 250 is placed outside the memory controller 230. The power-down prospector 250 may predict interruption of a power supply to send the predicted result to the memory controller 230. The memory controller 230 may select an address allocation manner at a write operation according to the predicted result of the power-down prospector 250. For example, if the predicted result indicates the interruption of a power supply, the memory controller 230 may assign an address having the shortest program time at the write operation.

The memory system according to an embodiment of the inventive concepts may be applied to a memory card.

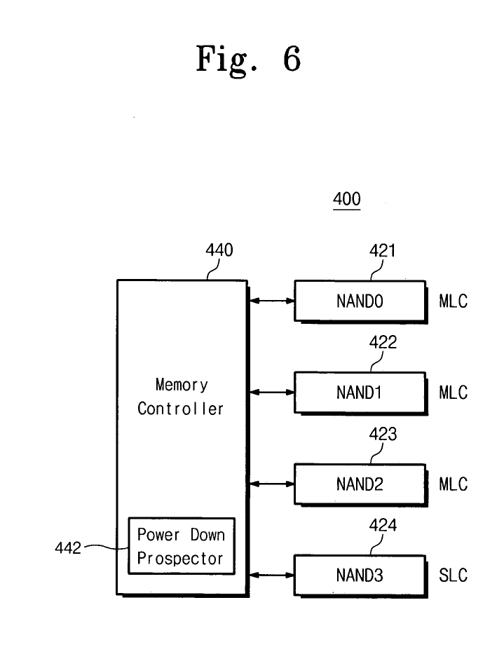

FIG. 5 is a block diagram showing a memory system according to still another embodiment of the inventive concepts.

Referring to FIG. 5, a memory card 300 may include a flash memory 320 for storing data and a memory controller 340 for controlling the flash memory 320. The flash memory 320 may have program times which are different from one another based on the address. For example, the flash memory 320 may include an area having single level cells and an area having multi-level cells. The memory controller 340 may include a power-down predicting algorithm/function as described in FIG. 1. The memory controller 340 may be realized such that there is assigned an address having the shortest program time at a write operation executed when interruption of a power supply is predicted.

The memory card 300 may be at least one of a Secure Digital (SD) card, Multi Media Card (MMC), eXtreme Digital (xD) card, Compact Flash (CF) card, Smart Media (SM) card, memory stick, PC card (PCMCIA), MMC/RS-MMC/MMCmicro, SD/miniSD/microSD, UFS, and the like.

FIG. 6 is a block diagram a memory system according to yet another embodiment of the inventive concepts.

Referring to FIG. 6, a memory system 400 may include a plurality of NAND flash memories 421, 422, 423, and 424 and a memory controller 440 for controlling the NAND flash memories 421˜424. The NAND flash memories 421, 422, and 423 may be formed of multi-level cells, and the NAND flash memory 424 may be formed of single level cells. A program time of each of the NAND flash memories 421, 422, and 423 may be different from that of the NAND flash memory 424.

The memory controller 440 may include a power-down prospector 442, which is realized to predict interruption of a power supply of the memory system 400. When the interruption of a power supply is predicted by the power-down prospector 442, data to be written may be programmed in the NAND flash memory 424 under the control of the memory controller 440. This is because a program time of a single level cell is generally shorter than that of a multi-level cell.

In FIG. 6, there is illustrated a memory system including four NAND flash memories. However, an embodiment of the inventive concepts is not limited thereto and may include a various number of NAND flash memories.

In accordance with embodiments of the inventive concepts, a memory controller is configured such that data is programmed in a specific memory block together with an address associated with the data when interruption of a power supply is predicted. After a power supply is resumed, the memory controller may judge whether data is programmed in a specific block when interruption of a power supply was predicted. If so, the memory controller reads the data and its associated address to program the data in a memory block corresponding to the associated address. Afterwards, the memory controller may update changed mapping information and erase a memory block which was used to store data when interruption of a power supply was predicted.

A memory system according to an embodiment of the inventive concepts may be applied to Solid State Drive (SSD).

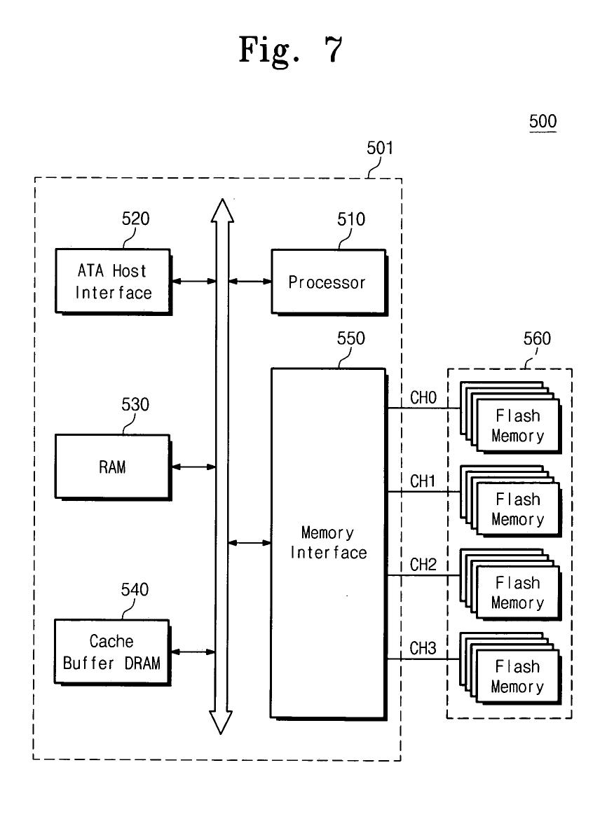

FIG. 7 is a block diagram showing a Solid State Drive (SSD) to which memory systems according to embodiments of the inventive concepts are applied.

Referring to FIG. 7, an SSD memory system 500 may include a memory controller 501 and a storage medium 560 formed of a plurality of flash memories. The memory controller 501 may include a function of a memory controller 130 illustrated in FIG. 1, for example, an address allocation manner of flash translation layer (FTL) described in FIGS. 1 to 3.

A processor 510 may control an overall operation of the memory system 500, for example, the SSD. An ATA host interface 520 may exchange data with the host according to the control of the processor 510. The ATA host interface 520 receives commands and addresses from the host to transfer the received commands and addresses to the processor 510 through the CPU bus. Herein, the ATA host interface 520 may be one of a serial ATA (SATA), a parallel ATA (PATA), an external SATA (ESATA), and the like. Alternatively, the host interface 520 may be configured to communicate with the host via one of interface protocols such as USB, MMC, PCI-E, ATA (Advanced Technology Attachment), Serial-ATA, Parallel-ATA, SCSI, ESDI, and IDE (Integrated Drive Electronics).

Data received from the host via the interface 520 or data to be transferred to the host may be sent through a cache buffer RAM 540 under the control of the processor 510 without passing through the CPU bus. RAM 530 may be used to store data which is necessary for an operation of the memory system 500. The RAM 530 may be formed of DRAM, SRAM, or the like.

The cache buffer RAM 540 may store data transferred between the host and the storage medium 560. The cache buffer RAM 540 may be used to store programs to be operated by the processor 510. The cache buffer RAM 540 may be a sort of a buffer memory and be formed of SRAM.

The memory interface 550 may be configured to exchange data with the storage medium 560. The memory interface 550 may be configured to interface with a NAND flash memory, a One-NAND flash memory, a multi-level flash memory, a single level flash memory, or the like.

It is possible to reduce a write time at interruption of a power supply by applying an address allocation manner of FTL to the memory system 500. Data in a RAM, such as the RAM 530, may be safely stored in the storage medium 560 at interruption of a power supply. As a result, data stability may be bettered at interruption of a power supply of the memory system.

Memory systems according to embodiments of the inventive concepts may be applied to a mobile (portable) storage device. For example, memory systems according to embodiments of the inventive concepts may be applied to storage devices such as MP3, digital camera, PDA, e-Book, and the like. Further, memory systems according to embodiments of the inventive concepts may be applied to storage devices of digital TV, computer, and the like.

Memory systems or flash memories according to embodiments of the inventive concepts may be packed by various packages such as PoP (Package on Package), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), and the like.

The above-disclosed subject matter is to be considered illustrative, and not restrictive, and the appended claims are intended to cover all such modifications, enhancements, and other embodiments, which fall within the true spirit and scope. Thus, to the maximum extent allowed by law, the scope is to be determined by the broadest permissible interpretation of the following claims and their equivalents, and shall not be restricted or limited by the foregoing detailed description.

What is claimed is:

1. An address allocating method of a flash translation layer, comprising:
judging whether interruption of a power supply is predicted; and
assigning one of a plurality of addresses having different program times according to a result of the judgment.

2. The address allocating method of claim 1, wherein the assigning assigns an address having a shorter program time from among the plurality of addresses if the judging predicts interruption of the power supply.

3. The address allocating method of claim 1, wherein the judging predicts interruption of the power supply based on sensing a voltage level of at least one of a data line and a power line.

4. The address allocating method of claim 1, wherein the judging predicts interruption of the power supply based on receiving an external power-down command.

5. A memory system comprising:
a flash memory having at least two addresses with different program times; and
a memory controller configured to control the flash memory, wherein
the memory controller is configured to assign an address corresponding to a shorter program time from among the at least two addresses for a write operation executed at interruption of a power supply to the flash memory, where the assigned address is used to store data of the memory controller in the flash memory.

6. The memory system of claim 5, further comprising:
an auxiliary power supply device configured to supply an auxiliary power supply for a first time at the interruption of the power supply.

7. The memory system of claim 5, further comprising:
a power line configured to supply an auxiliary power supply to the flash memory for a first time at the interruption of the power supply;
and a data line configured to provide the data to the flash memory, wherein
the power line is longer in length than the data line.

8. The memory system of claim 7, wherein the memory controller is configured to predict interruption of the power supply based on sensing a voltage level of at least one of the data line and the power line.

9. The memory system of claim 5, wherein,
the flash memory includes a first area having single level cells and a second area having multi-level cells,
the memory controller is configured to store the data in the first area if interruption of the power supply is predicted.

10. The memory system of claim 5, further comprising:
a separate line configured to receive and transmit to the memory controller an external power-down signal indicating interruption of the power supply, where the memory controller is configured to predict interruption of the power supply based on the external power-down signal.

11. The memory system of claim 5, wherein the flash memory comprises:
at least one flash memory having single level cells; and
a plurality of flash memories each having multi-level cells,
wherein the memory controller is configured to store data in the at least one flash memory having the single level cells if interruption of the power supply is predicted.

12. A memory system comprising:
a storage medium including a plurality of storage spaces with different program times; and
a memory controller including a buffer memory for temporarily retaining data to be stored in the storage medium, wherein
the memory controller is configured to predict interruption of a power supply to the storage medium,
the memory controller is configured to control the storage medium such that the data in the buffer memory is stored in a storage space having a shorter program time than that of at least another storage space from the among the plurality of storage spaces if the memory controller predicts interruption of the power supply.

13. The memory system of claim 12, wherein the memory controller further comprises:
a power-down prospector configured to predict interruption of the power supply.

14. The memory system of claim 12, wherein the storage medium includes at least one flash memory.

15. The memory system of claim 12, wherein at least one of the plurality of storage spaces includes single level cells and at least another of the plurality of storage spaces includes multi-level cells.

16. The memory system of claim 12, wherein at least one of the plurality of storage spaces includes cells for storing least significant bits (LSB) of the data and another of the plurality of storage spaces includes cells for storing most significant bits (MSB) of the data.

17. The memory system of claim 12, wherein the memory controller is configured to select one of at least two address allocation protocols based on the predicted interruption of the power supply.

18. The memory system of claim 17, wherein the memory controller is configured to assign an address of the storage medium to the data stored in the buffer memory such that the data in the buffer memory is stored in the storage space having the shorter program time, in accordance with one of the at least two address allocation protocols, if the memory controller predicts interruption of the power supply.

19. The memory system of claim 17, wherein the memory controller assigns an address of the storage medium to the data stored in the buffer memory based on a mapping table, in accordance with one of the at least two address allocation protocols, if the memory controller predicts no interruption of the power supply.

20. The memory system of claim 12, wherein the storage medium, the buffer memory, and the memory controller constitute are included in at least one of a Solid State Drive, a memory card, an MP3 player, a digital camera, a digital television (TV), Personal Digital Assistant (PDA), a printer, a computer, and a moving picture reproducing device.

21. The memory system of claim 12, wherein the memory controller is configured to predict interruption of the power supply based on information provided externally from the memory system.

22. The memory system of claim 12, wherein the memory controller is configured to predict interruption of the power supply based on sensing a voltage level of at least one of a data line providing the data and a power line providing the power supply of the storage medium.
